(19) United States
(12) Patent Application Publication
(10) Pub. No.: US 2016/0371211 A1
(43) Pub. Date: Dec. 22, 2016

(54) BUS-BIT-ORDER ASCERTAINMENT

(71) Applicant: APPLE INC., Cupertino, CA (US)

(72) Inventors: Ori Isachar, Herzliya Pituach (IL); Gil Semo, Herzliya Pituach (IL); Guy Kushtai, Herzliya Pituach (IL); Tal Lazmi, Herzliya Pituach (IL)

(21) Appl. No.: 14/806,795

(22) Filed: Jul. 23, 2015

Related U.S. Application Data
(60) Provisional application No. 62/180,080, filed on Jun. 16, 2015.

(51) Int. Cl. G06F 13/40; G06F 13/28

(52) U.S. Cl. CPC G06F 13/4013; G06F 13/4022; G06F 13/287

(57) ABSTRACT

An apparatus for use with a memory device that has a plurality of memory-device terminals having respective unique bit significances is described. The apparatus includes a memory controller, which includes (i) a plurality of external terminals, each one of the external terminals configured to be in communication with a respective one of the memory-device terminals, (ii) a plurality of internal terminals having respective unique bit significances, (iii) a switching unit, and (iv) a processor. The processor is configured to drive the memory device to communicate a predetermined sequence of bit patterns to the controller, and, in response to the sequence of bit patterns, drive the switching unit to connect each one of the external terminals to a respective one of the internal terminals having the bit significance of the memory-device terminal with which the external terminal is in communication. Other embodiments are also described.

### CROSS-REFERENCE TO RELATED APPLICATIONS

The present application claims the benefit of U.S. Provisional Application 62/180,080, filed Jun. 16, 2015, whose disclosure is incorporated herein by reference.

### FIELD OF THE DISCLOSURE

Embodiments described herein relate generally to communication over a bus, and specifically to ascertaining the bit order of terminals connected to a bus.

### BACKGROUND

Electronic devices that communicate with one another, such as a memory controller and a memory device, are often interconnected by a parallel bus (henceforth “bus”). A bus comprises multiple lines that are connected to respective terminals (e.g., pads) on each of the devices.

### SUMMARY

There is provided, in accordance with some embodiments of the present invention, an apparatus for use with a memory device that has a plurality of memory-device terminals having respective unique bit significances. The apparatus includes a memory controller, which includes (i) a plurality of external terminals, each one of the external terminals configured to be in communication with a respective one of the memory-device terminals, (ii) a plurality of internal terminals having respective unique bit significances, (iii) a switching unit, and (iv) a processor. The processor is configured to drive the memory device to communicate a predetermined sequence of bit patterns to the controller, and, in response to the sequence of bit patterns, drive the switching unit to connect each one of the external terminals to a respective one of the internal terminals having the bit significance of the memory-device terminal with which the external terminal is in communication.

In some embodiments,

the switching unit includes a plurality of multiplexers, and

the processor is configured to drive the switching unit to connect each one of the external terminals to the respective one of the internal terminals by controlling the multiplexers.

In some embodiments, each one of the multiplexers is connected to (i) a respective one of the external terminals, and (ii) at least two of the internal terminals.

In some embodiments, each one of the multiplexers is connected to (i) a respective one of the internal terminals, and (ii) at least two of the external terminals.

In some embodiments, the switching unit is configured to preserve connections between the internal terminals and the external terminals, following a powering-down of the controller.

In some embodiments, the sequence of bit patterns includes at least N−1 bit patterns, N being a number of the external terminals, each of the at least N−1 bit patterns including exactly one bit having a value selected from the group consisting of: 0, and 1,

the processor being configured to drive the memory device to communicate the sequence to the controller.

In some embodiments, the processor is configured to drive the memory device to communicate the predetermined sequence of bit patterns to the controller by communicating a reset command to the memory device.

In some embodiments, the processor is configured to:

communicate a reset command to the memory device, and

following the communication of the reset command and before beginning regular communication with the memory device, by communicating one or more driving signals to the memory device, drive the memory device to communicate the predetermined sequence of bit patterns to the controller.

In some embodiments, the processor is configured to, by communicating each one of the driving signals to the memory device, drive the memory device to communicate a respective one of the bit patterns to the controller.

In some embodiments, the processor is configured to drive the memory device to communicate the predetermined sequence of bit patterns to the controller by communicating exactly one driving signal to the memory device.

There is further provided, in accordance with some embodiments of the present invention, an apparatus for use with a memory controller. The apparatus includes a memory device, configured to receive a reset command from the controller, and, in response to the reset command, communicate a predetermined sequence of bit patterns to the controller.

In some embodiments, the memory device is further configured to receive, following the reset command, at least one driving signal from the controller, and the memory device is configured to communicate the predetermined sequence of bit patterns to the controller in response to the reset command and the at least one driving signal.

In some embodiments, the memory device is a NAND flash memory device.

There is further provided, in accordance with some embodiments of the present invention, an apparatus for use with a memory device. The apparatus includes (i) a memory controller, which includes a plurality of external terminals configured to connect to the memory device via a bus, (ii) a plurality of internal terminals having respective unique bit significances, and (iii) a switching unit configured to connect each one of the external terminals with any one of the internal terminals.

There is further provided, in accordance with some embodiments of the present invention, a method for facilitating communication between a memory controller and a memory device that has a plurality of memory-device terminals having respective unique bit significances. A processor of the memory controller drives the memory device to communicate a predetermined sequence of bit patterns to the controller, and, in response to the sequence of bit patterns, the processor drives a switching unit to connect each external terminal of the memory controller to a respective one of internal terminals of the memory controller having the bit significance of the memory-device terminal with which the external terminal is in communication.

In some embodiments, the switching unit includes a plurality of multiplexers, and driving the switching unit to connect each one of the external terminals to the respective one of the internal terminals includes driving the switching unit to connect each one of the external terminals to the respective one of the internal terminals by controlling the multiplexers.

In some embodiments, driving the memory device to communicate the sequence includes driving the memory device to communicate the sequence by communicating a reset command to the memory device.

In some embodiments, the method further includes communicating a reset command to the memory device, and driving the memory device to communicate the sequence includes, following the communication of the reset command and before beginning regular communication with the memory device, driving the memory device to communicate the sequence.

In some embodiments, driving the memory device to communicate the predetermined sequence of bit patterns to the controller includes communicating a plurality of driving signals to the memory device, each of the driving signals driving the memory device to communicate a respective one of the bit patterns to the controller.

In some embodiments, driving the memory device to communicate the predetermined sequence of bit patterns to the controller includes driving the memory device to communicate the predetermined sequence of bit patterns to the controller by communicating exactly one driving signal to the memory device.

In some embodiments, the sequence of bit patterns includes at least N−1 bit patterns, N being a number of the external terminals, each of the at least N−1 bit patterns including exactly one bit having a value selected from the group consisting of: 0, and 1,

the method including driving the memory device to communicate the sequence to the controller.

There is further provided, in accordance with some embodiments of the present invention, an apparatus for use with a memory device. The apparatus includes a memory controller, which includes a switching unit and a processor. The processor is configured to drive the memory device to communicate a predetermined sequence of bit patterns to the controller, and, in response to the sequence of bit patterns, set a bus bit order of the controller by controlling the switching unit.

In some embodiments, the switching unit is configured to preserve connections between internal terminals of the memory controller and external terminals of the memory controller, following a powering-down of the controller.

In some embodiments, the processor is configured to:

communicate a reset command to the memory device; and

following the communication of the reset command and before beginning regular communication with the memory device, by communicating one or more driving signals to the memory device, drive the memory device to communicate the predetermined sequence of bit patterns to the controller.

There is further provided, in accordance with some embodiments of the present invention, an apparatus including (i) a first memory device having a first bus bit order, (ii) a second memory device having a second bus bit order that is different from the first bus bit order, and (iii) a memory controller that includes a processor and is connected to both the first memory device and the second memory device. The processor is configured to alternate a bus bit order of the controller between the first bus bit order and the second bus bit order.

Embodiments described herein will be more fully understood from the following detailed description of embodiments thereof, taken together with the drawings, in which:

### BRIEF DESCRIPTION OF THE DRAWINGS

FIG. 1A is a schematic illustration of a memory controller in communication with a first memory device, in accordance with some embodiments described herein;

FIG. 1B is a schematic illustration of the memory controller of FIG. 1A in communication with a second memory device, in accordance with some embodiments described herein;

FIGS. 2A and 2B are schematic illustrations of a switching unit, in accordance with some embodiments described herein;

FIG. 3 is a flow chart for a method for ascertaining a bit order and driving a switching unit in response thereto, in accordance with some embodiments described herein;

FIG. 4 is a schematic illustration of an example embodiment of some portions of the method of FIG. 3;

FIG. 5 shows a variation of a portion of the method of FIG. 3, in accordance with some embodiments described herein;

FIG. 6 shows signals communicated by a processor in issuing a reset command, in accordance with some embodiments described herein; and

FIG. 7 shows signals exchanged between a processor and a memory device, in accordance with some embodiments described herein.

### DETAILED DESCRIPTION OF EMBODIMENTS

### Overview

The “bit order” of the terminals on a given device refers to the order of the bit significances of the terminals. For example, if the terminals of a memory device are physically arranged in order of increasing bit significance, the bit order of the terminals of the memory device (henceforth “memory-device bus bit order”) is from least-significant bit to most-significant bit. In general, the memory-device bus bit order may vary between different makes and/or models of memory devices. For a memory controller to communicate successfully with a memory device over a bus, each memory-controller terminal must be connected to a memory-device terminal having the same bit significance as the memory-controller terminal.

Embodiments described herein include a controller comprising a processor configured to ascertain the bus bit order of the memory device with which the controller is in communication, by driving the memory device to communicate a predetermined sequence of bit patterns to the controller. In response to ascertaining the memory-device bus bit order, the processor sets the bit order of the controller terminals (henceforth “controller bus bit order”) to “match” the ascertained memory-device bus bit order, such that each controller terminal is connected to the memory-device terminal having the same bit significance as the controller terminal. Hence, embodiments described herein provide at least the following advantages:

(a) The controller may be connected to a memory device having any arbitrary bus bit order, with relatively little (e.g., no) crossing-over of the bus lines that connect the controller to the memory device.

(b) The controller bus bit order may be set automatically, at any time during the lifetime of the controller. There is no need to manually set the controller bus bit order at the time the controller is connected to a particular memory device.

(c) The controller may be connected to a plurality of memory devices having different respective bus bit orders.

### System Description

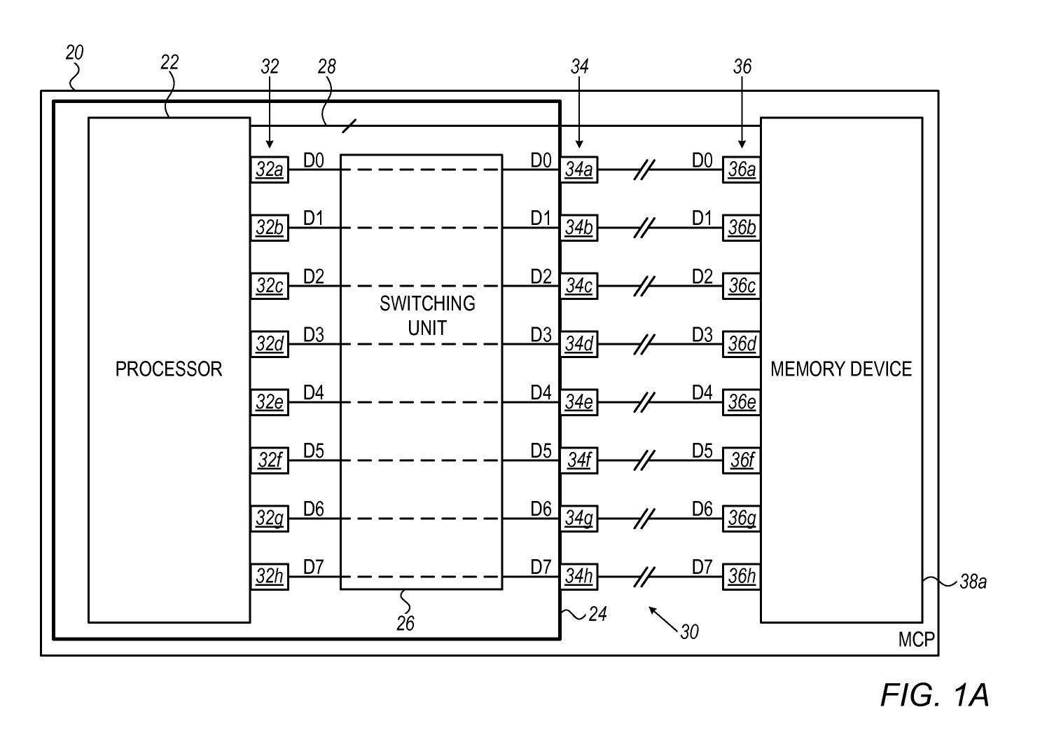

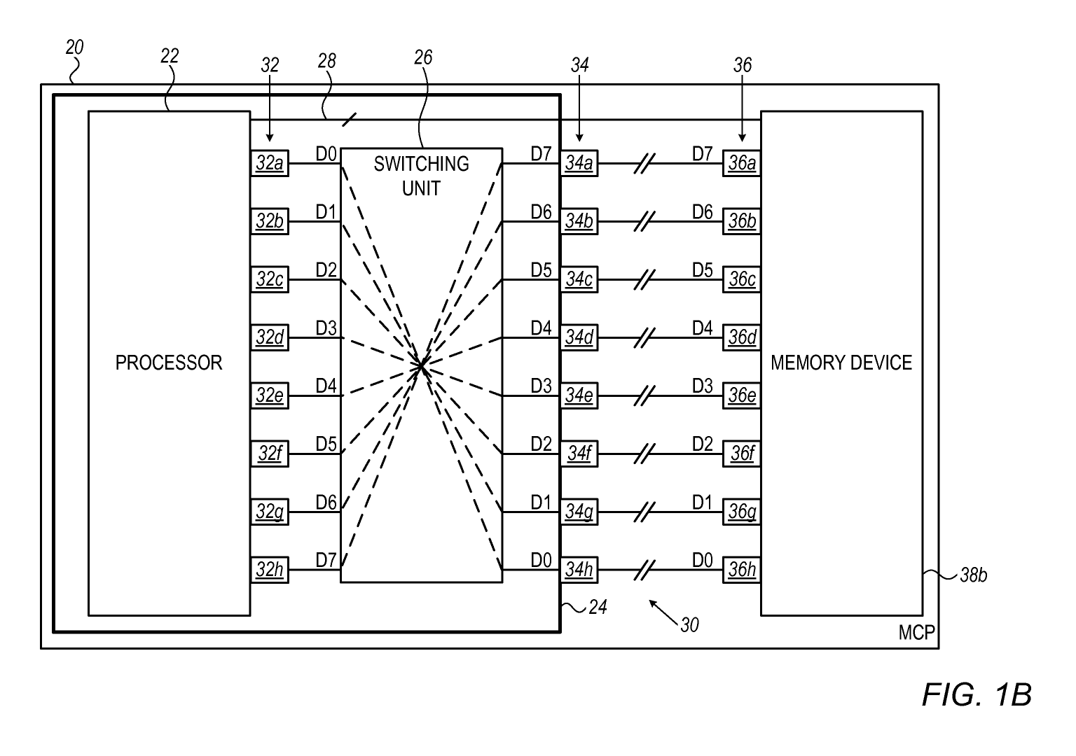

Reference is now made to FIG. 1A, which is a schematic illustration of a memory controller 24 in communication with a first memory device 38a on a multi-chip package (MCP) 20, in accordance with some embodiments described herein. Memory device 38a may include, for example, a NAND flash die or any other suitable type of volatile or non-volatile memory device.

Memory device 38a and memory controller 24 communicate with one another over a data bus 30, an address bus (not shown), and multiple control lines 28. The memory device has a plurality of memory-device terminals 36, which are used by the memory device as input/output (I/O) terminals for communication over data bus 30. For example, FIG. 1A shows eight memory-device terminals 36a through 36h, such that data is transferred between controller 24 and the memory device one byte at a time. (It is noted that embodiments described herein may be applied, mutatis mutandis, to cases in which the memory device has a greater number of terminals, e.g., 16 or 32 terminals.)

The memory-device terminals have respective unique bit significances. For example, FIG. 1A shows terminal 36a having a bit significance of “0,” such that the data bit that is input or output on terminal 36a is labeled “D0.” Similarly, terminal 36h is shown having a bit significance of “7,” such that the data bit that is input or output on terminal 36h is labeled “D7.” (Terminal 36a thus exchanges the least significant bit in the byte that is exchanged between the memory device and the controller, while terminal 36h exchanges the most significant bit.) Terminals 36b, 36c, 36d, 36e, 36f, and 36g correspond to bit significances 1 through 6, respectively. Thus, for example, the memory device outputs the byte “10100100” by outputting a “1” on terminal 36h, a “0” on terminal 36g, a “1” on terminal 36f, etc.

Controller 24 comprises a processor 22, which receives data from memory device 38a over data bus 30 (e.g., during a “read” operation), and sends information to the memory device over the data bus (e.g., during a “write” operation). Processor 22 may comprise a CPU that executes software-based instructions, and/or any other suitable circuitry, e.g., hardware logic circuitry implementing a state machine.

Processor 22 exchanges control signals with memory device 38a over control lines 28. The control signals may include, for example, an Address latch enable (ALE) signal, a Chip enable (CEn) signal, a Command latch enable (CLE) signal, a Ready/busy (RnB) signal, a Read enable (REn) signal, and/or a Write enable (WEn) signal. (When operating in double data rate (DDR) mode, the control signals may include a differential or single-ended strobe (DQS) signal, instead of the WEn signal. In general, it is noted that embodiments described herein may be used with any suitable interface mode.)

For example, to retrieve information from the memory device for a “read” operation, the controller transmits the appropriate control signals to the memory device, and subsequently, the memory device begins to output the appropriate sequence of bytes. To facilitate communication between controller 24 and memory device 38a, the controller further comprises a plurality of external terminals 34, which are used by the controller as I/O terminals for communication over data bus 30.

Each one of external terminals 34 is in communication via data bus 30 with a respective one of the memory-device terminals. For example, in FIG. 1A, external terminal 34a is in communication with memory-device terminal 36a, external terminal 34b with memory-device terminal 36b, external terminal 34c with memory-device terminal 36c, external terminal 34d with memory-device terminal 36d, external terminal 34e with memory-device terminal 36e, external terminal 34f with memory-device terminal 36f, external terminal 34g with memory-device terminal 36g, and external terminal 34h with memory-device terminal 36h.

The controller further comprises a plurality of internal I/O terminals 32 having respective unique bit significances, and a switching unit 26 that connects each one of external terminals 34 to the appropriate internal terminal 32. For example, FIG. 1A shows switching unit 26 connecting external terminal 34a to internal terminal 32a, external terminal 34b to internal terminal 32b, external terminal 34c to internal terminal 32c, external terminal 34d to internal terminal 32d, external terminal 34e to internal terminal 32e, external terminal 34f to internal terminal 32f, external terminal 34g to internal terminal 32g, and external terminal 34h to internal terminal 32h.

In general, the connections between the internal terminals and the external terminals determine the controller bus bit order. (Thus, for example, external terminal 34a is labeled “D0” in FIG. 1A, because it is connected to internal terminal 32a, which has bit significance “0.”) As further described hereinbelow, the processor sets the bus bit order of the controller by controlling the switching unit.

It is noted that external terminals 34 may in fact not be located externally to controller 24. Nonetheless, the term “external” is used to describe these terminals, in that they are generally “externally-facing,” i.e., they typically connect directly to the data bus.

Reference is now made to FIG. 1B, which is a schematic illustration of memory controller 24 in communication with a second memory device 38b having a different bus bit order from that of first memory device 38a, in accordance with some embodiments described herein. In the particular example shown in FIG. 1B, the memory-device bus bit order of second memory device 38b is reversed relative to that of first memory device 38a, such that terminal 36a in the second memory device has a bit significance of “7,” and terminal 36h has a bit significance of “0.”

If the bus bit order of controller 24 were unchangeable, connecting the controller to memory device 38b might necessitate crossing over the lines of bus 30. Since, however, the bus bit order of controller 24 is changeable, such crossing-over of the bus lines may not be necessary, as shown in FIG. 1B. Furthermore, by using the techniques for bus-bit-order ascertainment described hereinbelow, the controller bus bit order may be automatically set to match the bit order of memory device 38b, anytime during the lifetime of the controller. (In fact, in typical embodiments, the controller bus bit order may be automatically set to match any arbitrary memory-device bit order, for any memory device.)

The “//” symbols shown on the lines of data bus 30 in FIGS. 1A-B indicate that the controller and memory device may be arranged in any suitable arrangement on MCP 20. For example:

(i) the controller and memory device may be arranged opposite one another; or

(ii) the controller and memory device may be stacked on top of one another, as is typically the case when the controller is connected to more than one memory device. For example, with reference to FIG. 1A, in some cases, memory device 38a may be (a) positioned above or below the controller, and (b) rotated by 180 degrees, such that memory device 38a is upside-down with respect to the orientation shown in FIG. 1A. In such a case, to avoid crossed-over bus lines to the extent possible, it may be advantageous to connect memory-device terminal 36h (“D7”) to external terminal 34a of the controller instead of to external terminal 34h, memory-device terminal 36g (“D6”) to external terminal 34b of the controller instead of to external terminal 34g, etc. Embodiments described herein allow the controller to accommodate such connections.

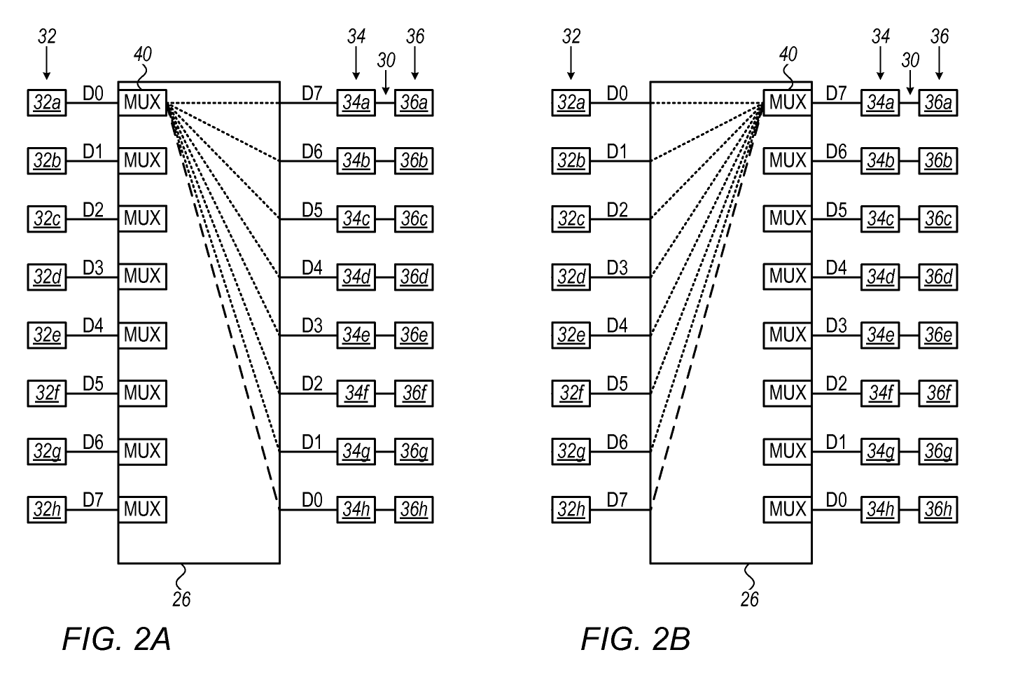

Reference is now made to FIGS. 2A-B, which are schematic illustrations of switching unit 26, in accordance with some embodiments described herein. FIGS. 2A-B show the switching unit in the context of the “reversed bit order” scenario depicted in FIG. 1B. However, FIGS. 2A-B differ from FIG. 1B, in that (i) for simplicity, some elements of FIG. 1B (e.g., processor 22 and memory device 38b) are omitted from FIGS. 2A-B, and (ii) FIGS. 2A-B shown some of the “internal workings” of switching unit 26 that are not shown in FIG. 1B.

As shown in FIGS. 2A-B, switching unit 26 may comprise a plurality of switches, such as multiplexers (MUX) 40. Multiplexers 40 provide multiple alternative connections between the internal and external terminals, such that the controller may set the connections between the internal and external terminals by controlling the multiplexers. For example, FIGS. 2A-B show an embodiment in which each of the external terminals may be connected to any one of the internal terminals. (Equivalently, it may be stated that each of the internal terminals may be connected to any one of the external terminals.) For example:

(i) As shown in FIG. 2A, each multiplexer 40 may be connected to (a) a respective one of internal terminals 32, and (b) all of external terminals 34. (For ease of illustration, FIG. 2A shows the alternative connections between the multiplexer and the external terminals for only one of the multiplexers.)

(ii) As shown in FIG. 2B, each multiplexer 40 may be connected to (a) a respective one of external terminals 34, and (b) all of internal terminals 32. (For ease of illustration, FIG. 2B shows the alternative connections between the multiplexer and the internal terminals for only one of the multiplexers.)

In other embodiments, multiplexers 40 may be configured to connect each of the internal terminals with only some of the external terminals. Thus, for example, one of the multiplexers may be configured to connect internal terminal 32a with either external terminal 34a or external terminal 34h, but not with any other external terminal.

As further described hereinbelow with reference to subsequent figures, processor 22 ascertains the memory-device bus bit order, and in response thereto, controls the switching unit, i.e., drives the switching unit to make the appropriate internal-external connections. For example, with reference to FIG. 2A, in response to ascertaining that the bit significance of memory-device terminal 36h is “0,” the processor may drive the switching unit to connect internal terminal 32a to external terminal 34h, rather than to any of the other external terminals. (This “appropriate” connection is depicted by the dashed line in FIG. 2A.) Similarly, with reference to FIG. 2B, in response to ascertaining that the bit significance of memory-device terminal 36a is “7,” the processor may drive the switching unit to connect external terminal 34a to internal terminal 32h, rather than to any of the other internal terminals. (This “appropriate” connection is depicted by the dashed line in FIG. 2B.)

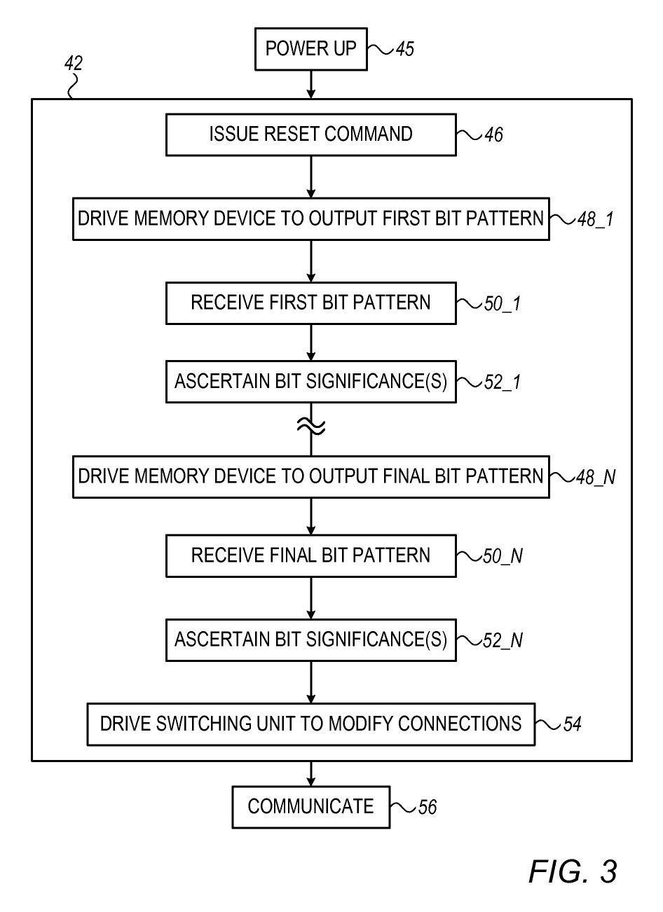

Reference is now made to FIG. 3, which is a flow chart for a method 42 for ascertaining the memory-device bus bit order, and driving the switching unit in response thereto, in accordance with some embodiments described herein. Method 42 may be described as a type of “discovery” protocol, which facilitates communication between the controller and the memory device, by ascertaining, for the controller, the memory-device bus bit order of the memory device. Each of the steps in method 42 is typically performed by the controller, and in particular, by processor 22. FIG. 3 provides a high-level overview of method 42, while subsequent figures provide various implementation details for method 42.

Method 42 begins following a power-up event 45, in which the controller and memory device are powered up. First, at a resetting step 46, the processor issues a reset command, which is received by the memory device. The memory device is configured to, in response to the reset command, communicate a predetermined sequence of bit patterns to the controller, as described immediately hereinbelow. (The sequence of bit patterns is described and claimed herein as being “predetermined,” in that the processor is configured to expect the exact sequence that the memory device is configured to communicate.)

Typically, following resetting step 46, the processor drives the memory device (e.g., via control lines 28 (FIGS. 1A-B)) to communicate a predetermined sequence of N bit patterns (e.g., N bytes), by communicating one or more signals to the memory device. For example, FIG. 3 shows the processor driving the memory device to communicate a single bit pattern of the sequence in each of driving steps 48_1 through 48_N. That is, in first driving step 48_1, the processor drives the memory device to output the first bit pattern of the sequence; in final driving step 48_N, the processor drives the memory device to output the final bit pattern of the sequence; and, for N>2, in driving steps 48_2 through 48_(N−1) (not shown), the processor drives the memory device to output the second through penultimate bit patterns. Following each of the driving steps, the processor receives the communicated bit pattern. For example, following first driving step 48_1, the processor receives the first bit pattern, at a first receiving step 50_1; similarly, following final driving step 48_N, the processor receives the final bit pattern, at a final receiving step 50_N.

In response to the received bit patterns, the processor ascertains the respective bit significances of the memory-device terminals. There are various alternative ways in which the processor may ascertain the respective bit significances, two such ways being as follows:

(i) As shown in FIG. 3, the processor may ascertain at least one of the bit significances, following each of the receiving steps. For example, following first receiving step 50_1, the processor may perform a first ascertaining step 52_1, by which a bit significance is ascertained; similarly, following final receiving step 50_N, the processor may perform a final ascertaining step 52_N, by which a bit significance is ascertained. With the conclusion of final ascertaining step 52_N, the processor has ascertained the entire memory-device bus bit order.

(ii) The processor may ascertain each of the respective bit significances only following all of the receiving steps.

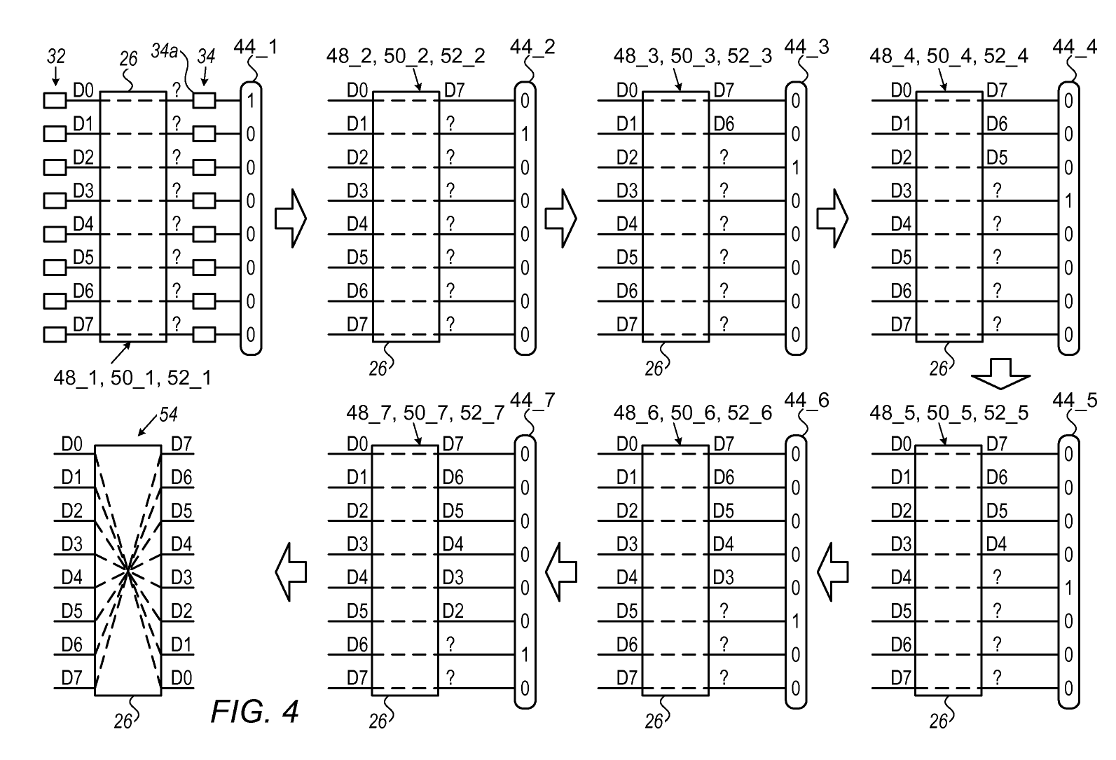

The way in which the processor ascertains the respective bit significances may be a function of the particular bit-pattern sequence that is used for method 42. For example, as described below with reference to FIG. 4, method 42 may employ a bit-pattern sequence that “allows” the processor to ascertain at least one of the bit significances following the receipt of each of the bit patterns, such that the processor may ascertain the respective bit significances in accordance with (i) above.

Following the ascertaining of the memory-device bus bit order, the processor drives the switching unit, at a driving step 54, to modify the internal-external connections of the switching unit in accordance with the ascertained memory-device bus bit order. In other words, as described hereinabove with reference to FIGS. 2A-B, the processor drives the switching unit to connect each one of the external terminals to a respective one of the internal terminals having the bit significance of the memory-device terminal with which the external terminal is in communication.

Following the performance of method 42, the controller and memory device may begin regular communication, at a communicating step 56. For example, the controller may read data from the memory device, and/or write data to the memory device.

Reference is now additionally made to FIG. 4, which is a schematic illustration of an example embodiment of some portions of method 42. In particular, FIG. 4 illustrates an example embodiment for the driving, receiving, and ascertaining steps described above with reference to FIG. 3, and additionally illustrates driving step 54. For simplicity, FIG. 4 omits many of the structural elements that are shown in FIGS. 1A-B and 2A-B. Also for simplicity, internal terminals 32 and external terminals 34 are shown in the first step of the figure, but are not shown in subsequent steps.

The sequence of steps shown in FIG. 4 begins at the top-left, with first driving step 48_1. Prior to first driving step 48_1, the memory-device bus bit order is completely unknown to the processor. (In other words, each of the external terminals is connected to a memory-device terminal of a bit significance that is unknown to the processor.) Hence, a “?” is shown for the bit significance to which each of the external terminals corresponds. Since the memory-device bus bit order is unknown to the processor, switching unit 26 initially connects each one of the external terminals to an arbitrary one of the internal terminals.

In driving step 48_1, following the driving of the memory device to communicate the first bit pattern 44_1, first bit pattern 44_1, “10000000,” is communicated from the memory device to the controller. A “1” is thus received at external terminal 34a, while a “0” is received at each of the other external terminals. (Per the arbitrary initial internal-external connections shown in FIG. 4, the “1” is received by the processor, at first receiving step 50_1, as the least significant bit of the bit pattern.) Since the processor “expects” to see “10000000” as the first bit pattern of the sequence, the processor ascertains, at first ascertaining step 52_1, that external terminal 34a corresponds to the most significant bit. Hence, following ascertaining step 52_1, FIG. 4 shows the relevant “?” replaced with “D7.”

Following ascertaining step 52_1, FIG. 4 shows:

(i) a second driving step 48_2 and a second receiving step 50_2 for a second bit pattern 44_2, and a second ascertaining step 52_2;

(ii) a third driving step 48_3 and a third receiving step 50_3 for a third bit pattern 44_3, and a third ascertaining step 52_3;

(iii) a fourth driving step 48_4 and a fourth receiving step 50_4 for a fourth bit pattern 44_4, and a fourth ascertaining step 52_4;

(iv) a fifth driving step 48_5 and a fifth receiving step 50_5 for a fifth bit pattern 44_5, and a fifth ascertaining step 52_5;

(v) a sixth driving step 48_6 and a sixth receiving step 50_6 for a sixth bit pattern 44_6, and a sixth ascertaining step 52_6; and

(vi) a seventh driving step 48_7 and a seventh receiving step 50_7 for a seventh bit pattern 44_7, and a seventh ascertaining step 52_7.

In each of ascertaining steps 52_2 through 52_6, the processor ascertains another one of the bit significances. In ascertaining step 52_7, in response to the final bit pattern 44_7, the processor ascertains the two remaining bit significances. Finally, in driving step 54, the processor drives switching unit 26 to connect each one of the external terminals to the appropriate internal terminal.

In some embodiments, the bit-pattern sequence has a length of at least N−1, N being the number of external terminals, and each of the bit patterns has exactly one “1” or “0.” For example, for N=8, FIG. 4 shows a sequence of seven bytes, each byte having exactly one “1”: “10000000,” “01000000,” “00100000,” “00010000,” “00001000,” “00000100,” and “00000010.”

Alternatively, method 42 may employ any other suitable sequence. For example, method 42 may employ a sequence consisting of log 2(N) bit patterns, N being the number of external terminals. Thus, for example, for N=8, one sequence that method 42 may employ is “11110000,” “11001100,” and “10101010.” Each of the bit patterns of such an alternative sequence halves the number of possible bit significances for each of the memory-device terminals, such that the processor ascertains the bit significance of each of the memory-device terminals following the receipt of the final bit pattern of the sequence. Hence, using such an alternative sequence, there is only one ascertaining step, in which all of the bit significances are ascertained, rather than a plurality of incremental ascertaining steps 52_1 through 52_N.

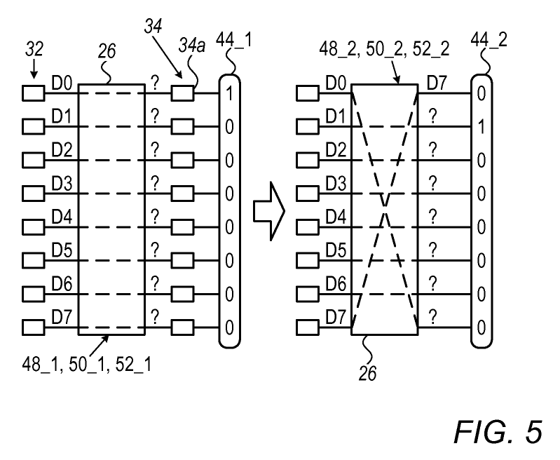

Reference is now made to FIG. 5, which shows a variation of a portion of method 42, in accordance with some embodiments described herein. In some embodiments, the processor drives the switching device to modify one or more of the internal-to-external connections even before all of the bit significances have been ascertained. For example, FIG. 5 shows an embodiment in which, following the ascertaining, in ascertaining step 52_1, that external terminal 34a corresponds to “D7,” the processor drives the switching unit to swap two of the internal-external connections, such that external terminal 34a becomes connected to the appropriate internal terminal. Such swapping of connections may similarly occur following any of the other ascertaining steps of method 42.

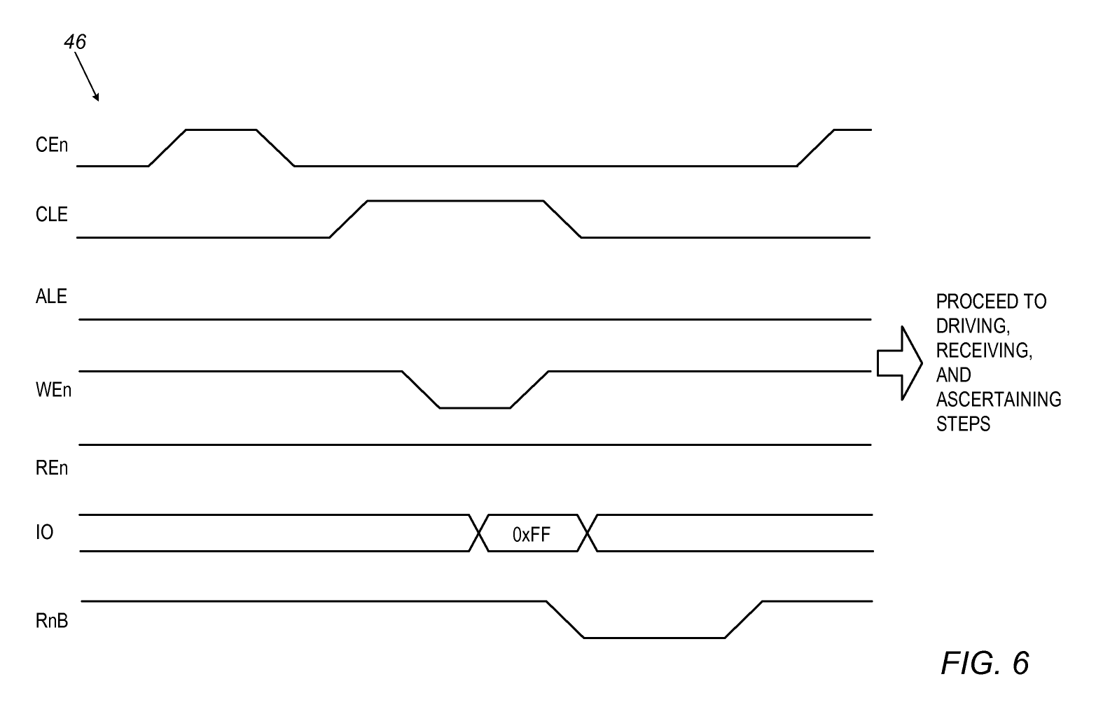

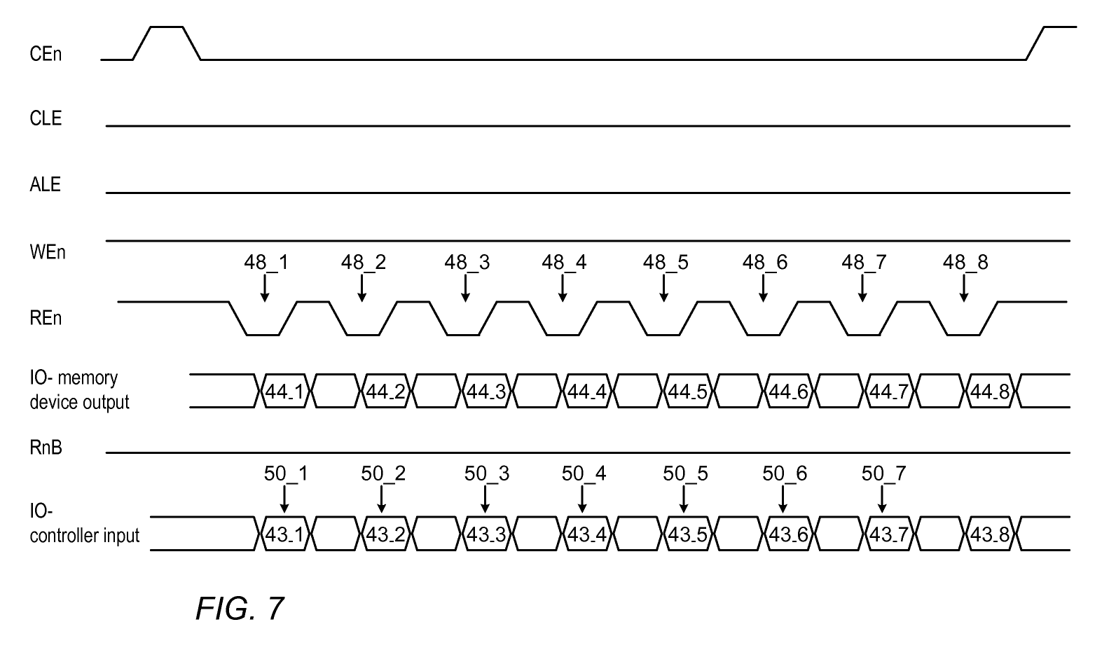

Reference is now made to FIG. 6, which shows signals communicated by the processor in issuing the reset command to the memory device during resetting step 46, in accordance with some embodiments described herein. It is noted that while FIGS. 6-7 depict the single data rate (SDR) mode of operation for NAND flash memory, in that it is common for NAND flash memory devices to power up in SDR mode, the scope of method 42 includes the exchange of signals in any other suitable mode of operation (such as the DDR mode), and/or with any other suitable type of memory device having parallel I/O terminals.

During resetting step 46, ALE remains low, REn remains high, and CEn, CLE, WEn, and RnB are toggled as shown. At the point in time indicated in the figure, the controller outputs an “IO” signal (or “opcode”) of “11111111,” indicated by the symbol “0xFF,” at terminals 34. Such an opcode, used for resetting NAND flash memory devices, is interpreted correctly by the memory device, regardless of the memory-device bus bit order. Similarly, techniques described herein may be used for any other type of memory device for which the reset opcode will be interpreted correctly by the memory device, regardless of the memory-device bus bit order.

Reference is now made to FIG. 7, which shows signals exchanged between the processor and the memory device during the driving and receiving steps of method 42, in accordance with some embodiments described herein. As shown in FIG. 7:

(i) CLE and ALE remain low, WEn remains high, and CEn is toggled as shown.

(ii) Each of driving steps 48_1 through 48_7, along with an “extra” driving step 48_8 (explained below), is effected by toggling REn as shown.

(iii) Following each of the driving steps, the memory device outputs another bit pattern of the bit-pattern sequence, as described hereinabove. The output of the bit patterns is represented by the “IO—memory-device output” signal in FIG. 7, which includes an “extra” bit pattern 44_8, “00000001,” output in response to driving step 48_8.

(iv) Each of the bit patterns is received by the processor, the receipt of the bit patterns being represented in FIG. 7 by the “IO—controller input” signal. Since the memory-device bus bit order is unknown to the processor, the processor may interpret the received bit patterns as “scrambled” bit patterns 43_1 through 43_8, instead of bit patterns 44_1 through 44_8, respectively. For example, assuming the “reversed bit order” scenario depicted in FIG. 1B, the processor interprets the received bit patterns as “00000001” (43_1), “00000010” (43_2), “00000100” (43_3), “00001000” (43_4), “00010000” (43_5), “00100000” (43_6), “01000000” (43_7), and “10000000” (43_8), respectively.

As noted above, for the sequence of bit-patterns shown in FIG. 4, bit pattern 44_7 may be the final bit pattern of the sequence. In some embodiments, however, as shown in FIG. 7, the processor drives the memory device to output extra bit pattern 44_8, which is not strictly required to ascertain the memory-device bus bit order, to help validate that the bit significances have been ascertained correctly, and/or to help validate proper bus connectivity.

The figures of the present application, and the above description thereof, generally relate to embodiments in which the controller explicitly drives the memory device to communicate the predetermined sequence of bit patterns, following the reset command. For example, as depicted by the toggling of the REn signal in FIG. 7, the controller may communicate a plurality of driving signals to the memory device, each of the driving signals driving the memory device to communicate a respective one of the bit patterns. It is noted, however, that the memory device may be configured to communicate the sequence in response to receiving the reset command, even without being subsequently driven by the controller to do so. (Thus, the controller may drive the memory device to communicate the sequence solely by communicating the reset command to the memory device.) For example, the memory device may be configured to, in response to receiving the reset command, communicate the sequence with a predetermined delay separating between the bit patterns. In some embodiments, following the reset command, the controller communicates exactly one driving signal to the memory device, and in response thereto, the memory device communicates the sequence, e.g., with a predetermined delay separating between the bit patterns.

In yet other embodiments, the memory device communicates the predetermined sequence to the controller, even without first receiving a reset command from the controller. For example, immediately following a powering-up of the memory device, the memory device may communicate the sequence, along with one or more “strobe” signals that notify the controller to expect the sequence, and/or otherwise facilitate the receipt of the sequence by the controller.

In some embodiments, the switching unit is memoryless. In such embodiments, method 42 is typically performed following each power-up event, in order to reset the internal-external connections. In other embodiments, the switching unit preserves the appropriate internal-external connections, following a powering-down of the controller. In such embodiments, method 42 is performed following the power-up event that precedes the controller and memory device communicating with one another for the first time, but is not necessarily performed following subsequent power-up events. Nevertheless, in such embodiments, method 42 might be at least partly re-performed in certain exceptional scenarios, such as following a power-up event that follows (i) a replacement of the memory device with a different make or model, or (ii) a changing of the connections between the controller and memory device.

Typically, the controller is connected to a plurality of memory devices over data bus 30, and the apparatus and techniques disclosed herein are used to facilitate communication between the controller and each of the connected memory devices. Typically, all of the memory devices with which the controller communicates share the same bus bit order; however, it is noted that embodiments described herein may also allow the controller to communicate with a plurality of memory devices whose bus bit orders differ from each other. That is, the controller may be connected to both (i) a first memory device having a first bus bit order, and (ii) a second memory device having a second bus bit order that is different from the first bus bit order. In such a situation, the processor may set the controller bus bit order to (i) the first bus bit order, prior to regular communication with the first memory device, and (ii) the second bus bit order, prior to regular communication with the second memory device. The controller bus bit order may thus alternate between the first bus bit order and the second bus bit order. In general, the controller may be connected to any number of memory devices, having, collectively, any number of different bus bit orders.

Although the description above relates mainly to communication between a controller and a memory device, it is noted that the apparatus and techniques described herein may be used to facilitate communication between any two devices connected to one another by a parallel bus, such as a pair of central processing units (CPUs), or a CPU and a memory device. It is further noted that the apparatus and techniques described herein may be applied to interconnected packaged devices, e.g., an interconnected memory device and controller on a printed circuit board, in addition to unpackaged devices in an MCP.

It will be appreciated by persons skilled in the art that the present invention is not limited to what has been particularly shown and described hereinabove. Rather, the scope of the present invention includes both combinations and subcombinations of the various features described hereinabove, as well as variations and modifications thereof that are not in the prior art, which would occur to persons skilled in the art upon reading the foregoing description. Documents incorporated by reference in the present patent application are to be considered an integral part of the application except that to the extent any terms are defined in these incorporated documents in a manner that conflicts with the definitions made explicitly or implicitly in the present specification, only the definitions in the present specification should be considered.

1. An apparatus for use with a memory device that has a plurality of memory-device terminals having respective unique bit significances, the apparatus comprising:
a memory controller, comprising:
a plurality of external terminals, each one of the external terminals configured to be in communication with a respective one of the memory-device terminals;
a plurality of internal terminals having respective unique bit significances;
a switching unit; and
a processor, configured to:
drive the memory device to communicate a predetermined sequence of bit patterns to the controller; and
in response to the sequence of bit patterns, drive the switching unit to connect each one of the external terminals to a respective one of the internal terminals having the bit significance of the memory-device terminal with which the external terminal is in communication.

2. The apparatus according to claim 1, wherein:
the switching unit comprises a plurality of multiplexers; and
the processor is configured to drive the switching unit to connect each one of the external terminals to the respective one of the internal terminals by controlling the multiplexers.

3. The apparatus according to claim 2, wherein each one of the multiplexers is connected to (i) a respective one of the external terminals, and (ii) at least two of the internal terminals.

4. The apparatus according to claim 2, wherein each one of the multiplexers is connected to (i) a respective one of the internal terminals, and (ii) at least two of the external terminals.

5. The apparatus according to claim 1, wherein the switching unit is configured to preserve connections between the internal terminals and the external terminals, following a powering-down of the controller.

6. The apparatus according to claim 1, wherein the sequence of bit patterns includes at least N−1 bit patterns, N being a number of the external terminals, each of the at least N−1 bit patterns including exactly one bit having a value selected from the group consisting of: 0, and 1,
the processor being configured to drive the memory device to communicate the sequence to the controller.

7. The apparatus according to claim 1, wherein the processor is configured to drive the memory device to communicate the predetermined sequence of bit patterns to the controller by communicating a reset command to the memory device.

8. The apparatus according to claim 1, wherein the processor is configured to:
communicate a reset command to the memory device; and
following the communication of the reset command and before beginning regular communication with the memory device, by communicating one or more driving signals to the memory device, drive the memory device to communicate the predetermined sequence of bit patterns to the controller.

9. The apparatus according to claim 8, wherein the processor is configured to, by communicating each one of the driving signals to the memory device, drive the memory device to communicate a respective one of the bit patterns to the controller.

10. The apparatus according to claim 8, wherein the processor is configured to drive the memory device to communicate the predetermined sequence of bit patterns to the controller by communicating exactly one driving signal to the memory device.

11. A method for facilitating communication between a memory controller and a memory device that has a plurality of memory-device terminals having respective unique bit significances, comprising:
driving, by a processor of the memory controller, the memory device to communicate a predetermined sequence of bit patterns to the controller; and
in response to the sequence of bit patterns, driving, by the processor, a switching unit to connect each external terminal of the memory controller to a respective one of internal terminals of the memory controller having the bit significance of the memory-device terminal with which the external terminal is in communication.

12. The method according to claim 11, wherein the switching unit includes a plurality of multiplexers, and wherein driving the switching unit to connect each one of the external terminals to the respective one of the internal terminals comprises driving the switching unit to connect each one of the external terminals to the respective one of the internal terminals by controlling the multiplexers.

13. The method according to claim 11, wherein driving the memory device to communicate the sequence comprises driving the memory device to communicate the sequence by communicating a reset command to the memory device.

14. The method according to claim 11, further comprising communicating a reset command to the memory device, wherein driving the memory device to communicate the sequence comprises, following the communication of the reset command and before beginning regular communication with the memory device, driving the memory device to communicate the sequence.

15. The method according to claim 11, wherein driving the memory device to communicate the predetermined sequence of bit patterns to the controller comprises communicating a plurality of driving signals to the memory device, each of the driving signals driving the memory device to communicate a respective one of the bit patterns to the controller.

16. The method according to claim 11, wherein driving the memory device to communicate the predetermined sequence of bit patterns to the controller comprises driving the memory device to communicate the predetermined sequence of bit patterns to the controller by communicating exactly one driving signal to the memory device.

17. The method according to claim 11, wherein the sequence of bit patterns includes at least N−1 bit patterns, N being a number of the external terminals, each of the at least N−1 bit patterns including exactly one bit having a value selected from the group consisting of: 0, and 1,
the method comprising driving the memory device to communicate the sequence to the controller.

18. An apparatus for use with a memory device, the apparatus comprising:
a memory controller, comprising:
a switching unit; and
a processor, configured to:
drive the memory device to communicate a predetermined sequence of bit patterns to the controller, and
in response to the sequence of bit patterns, set a bus bit order of the controller by controlling the switching unit.

19. The apparatus of claim 18, wherein the switching unit is configured to preserve connections between internal terminals of the memory controller and external terminals of the memory controller, following a powering-down of the controller.

20. The apparatus according to claim 18, wherein the processor is configured to:
communicate a reset command to the memory device; and
following the communication of the reset command and before beginning regular communication with the memory device, by communicating one or more driving signals to the memory device, drive the memory device to communicate the predetermined sequence of bit patterns to the controller.
